(19) United States
(12) Patent Application Publication
(10) Pub. No.: US 2002/0025422 A1
(43) Pub. Date: Feb. 28, 2002

(54) Printing web for use on printing cylinders, in particular for offset printing machines

(75) Inventors: Stefan Fullgraf, Duderstadt (DE); Jurgen Spilker, Katlenburg-Lindau (DE); Hans-Jurgen Tatsch, Einbeck (DE)

Correspondence Address: GREENBLUM & BERNSTEIN, P.L.C., 1941 ROLAND CLARKE PLACE, RESTON, VA, 20191, US

(73) Assignee: CONTITECH ELASTOMER-BESCHICHTUNGEN GmbH, Hannover (DE)

(21) Appl. No.: 09/837,455

(22) Filed: Apr. 19, 2001

(30) Foreign Application Priority Data
Apr. 20, 2000 (DE) 200 07 227.7
Apr. 6, 2001 (DE) 101 17 409.8

(51) Int. Cl. B32B 27/02

(52) U.S. Cl. 428/315.5; 428/319.3; 442/220

(57) ABSTRACT

Printing web for utilization on printing cylinders and process of producing printing web. Printing web includes an internal carrying layer arranged to face the printing cylinder during use of the printing web. The internal carrying layer includes a flexible metal sheet which is adaptable to a curvature of the printing cylinder and which is coupled to an adjacent layer via a bonding agent. The printing web also includes a microporous compressible intermediate layer, and an exterior printing layer.

### CROSS-REFERENCE TO RELATED APPLICATIONS

The present application claims priority under 35 U.S.C. § 119 of German Patent Application No. 200 07 227.7, filed on Apr. 20, 2000 and German Patent Application Number 101 17 409.8, filed on Apr. 6, 2001, the disclosures of which are expressly incorporated by reference herein in their entireties.

### BACKGROUND OF THE INVENTION

1. Field of the Invention

The invention relates to a printing web for use on printing cylinders, e.g., for offset printing machines, with an internal carrying layer facing the printing cylinder during use of the printing web, a microporous compressible intermediate layer, and an exterior printing layer. The invention also relates to a process for producing such a web.

2. Discussion of Background Information

A printing web made of an elastic, compressible printing element with closed-cell foam is known, e.g., from DE-OS 30 27 549. A stabilizing layer is arranged next to the layer containing the closed-cell foam in the direction towards the printing cylinder to ensure a small degree of change in length in the machine direction. Under certain conditions, such a layer can be replaced by an adhesive layer for the purpose of attaching the printing web to the transfer cylinder.

In such a solution, it remains open how the printing web is to be attached to the cylinder and how a secure adhesion of the layers of the printing web is guaranteed.

### SUMMARY OF THE INVENTION

The present invention provides a printing web and a process for the producing the same in such a way that the forces acting on the printing web during the printing process do not lead to increased tensions in the endangered regions of the printing web.

Accordingly, the printing web of the instant invention includes an inner carrying layer which, when using the printing web, is facing the printing cylinder and is formed of a type of flexible sheet metal that can be adapted to the curve of the printing cylinder. This layer is also connected to an adjoining layer by a bonding agent.

Further, the process of the present invention includes connecting the inner carrying layer, which is facing the printing cylinder when the printing web is in use, optionally to a microporous and/or compressible elastomer intermediate layer, an outer printing layer, and, optionally, to other layers. The carrying layer includes a metal plate that is flexible, which can be adapted to the curve of the printing cylinder and can be continuously provided in the form of rolls or strips, and which is subsequently connected to the adjoining layer.

The invention is connected to the advantage that, on the basis of the bonding agent connection between the carrying layer and the adjoining layer of the printing web, a defined conduction of the forces acting on the printing layer as they arise during the printing process is made possible in the layer structure of the printing web.

The adjoining layer can be the microporous, compressible intermediate layer or even a rubber-elastic compensating layer connected directly to this intermediate layer.

When using this rubber-elastic intermediate layer that does not contain any pores as a component of the printing web, the forces transmitted into the microporous, compressible elastomer intermediate layer are distributed evenly onto the carrying layer by way of the compensation layer.

Moreover, the lateral surfaces of the printing web can be provided with an elastomer covering. Such an elastomer covering prevents fluids used in the printing process or washing fluid used in cleaning the printing webs from arriving in the textile layer and ultimately shortening the service life of the printing web.

Here, the elastomer covering can constantly increase in its thickness originating from the printing layer and in the direction of the carrying layer. Such a construction effectively prevents particularly the tangential forces occurring in the printing process from leading to excessive tensions at the low end of the printing web, i.e., in the transitional region from the carrying layer to the adjoining layer of the printing web assembly.

If a continuous transition exists between the elastomer covering and the compensation layer, as can be achieved, e.g., by a hot vulcanization, the advantage described will be reinforced further.

In a further useful embodiment of the invention, the microporous, compressible elastomer intermediate layer contains materials for increasing the strength such as woven layers, foil pieces, or fibrous components such that it is possible to omit a strength support outside the microporous, compressible intermediate layer and arranged under the printing layer, e.g., in the form of woven layers.

In a preferred manner of performing the process, the outer printing layer, the microporous and/or compressible elastomers, intermediate layers, and, optionally, other layers, are connected into one unit, after which the connection of this unit to the metallic carrying layer is produced.

For another improvement of the product characteristics, the metallic carrying layer is connected to the layer adjoining the carrying layer by adhesion or cross-linking in such a way that, when the printing web is used, a minimum separation force>about 1.5 N/mm is achieved. Such a possibility also exists when, before this process step, the layer adjoining the carrying layer is already firmly connected to the remaining layers of the printing web structure.

If, e.g., a thickness of the microporous and/or compressible elastomer layer that determines the manner of functioning of the printing web is adjusted, it is useful to adjust the layer structure by means of removing particles, which layer structure includes the outer printing layer, the microporous and/or compressible elastomer intermediate layer, and, optionally, other layers, to a thickness that can be predetermined, after which the connection between the layer structure and the metallic carrying layer is produced by cross-linking or adhesion.

According to another useful performance of the process, a removal of particles from the printing layer occurs after the cross-linking or adhesion of the metallic carrying layer with the layer adjoining the metallic carrying layer. Thus, the thickness of the printing web can be adjusted to the desired amount. The option is also available of influencing the roughness and/or surface structure of the printing web.

The present invention is directed to a printing web for utilization on printing cylinders, that includes an internal carrying layer arranged to face the printing cylinder during use of the printing web. The internal carrying layer includes a flexible metal sheet which is adaptable to a curvature of the printing cylinder and which is coupled to an adjacent layer via a bonding agent. The printing web also includes a microporous compressible intermediate layer, and an exterior printing layer.

In accordance with a feature of the invention, the printing web can be adapted for use in offset printing machines.

According to another feature of the instant invention, the adjacent layer may include the microporous, compressible intermediate layer. Further, an elastomer covering can be provided on lateral surfaces of the printing web. The elastomer covering may be formed to continuously increase in thickness from the exterior printing web in a direction of the internal layer. Moreover, a continuous connection can be provided between the elastomer covering and the adjustment layer. The continuous connection may be created by a vulcanizing process, and the vulcanization process may include hot vulcanization.

Further, the adjacent layer may include a rubber-elastic adjustment layer which is directly connected to the microporous, compressible intermediate layer. Further, an elastomer covering may be provided on lateral surfaces of the printing web. The elastomer covering can be formed to continuously increase in thickness from the exterior printing web in a direction of the internal layer. A continuous connection can be provided between the elastomer covering and the adjustment layer. The continuous connection may be created by a vulcanizing process, and the vulcanization process may include hot vulcanization.

The microporous, compressible intermediate elastomer layer can include strength-enhancing materials, and the strength-enhancing materials may include at least one of layers of woven materials, foil sections, and fibrous components.

The instant invention is directed to a process for producing a printing web for use on printing cylinders having an interior carrying layer, including a flexible metal plate, that faces the printing cylinder during operation of the printing web and an exterior printing layer. The process includes forming the interior carrying layer with a flexible metal sheet in a shape of one of a roll and a strip, in which the flexible metal sheet is adaptable to a curvature of the printing cylinder, and coupling the flexible metal sheet with an adjacent layer.

According to a feature of the present invention, the printing web can be adapted for use in an offset printing press.

Further, the adjacent layer may include a microporous and compressible intermediate layer. The process can also include providing an elastomer covering on lateral surfaces of the printing web. The elastomer covering may be formed to continuously increase in thickness from the exterior printing web in a direction of the internal layer. Further, a continuous connection can be provided between the elastomer covering and the adjustment layer. The continuous connection may be created by a vulcanizing process, and the vulcanization process may include hot vulcanization.

The printing web can also include a microporous, compressible intermediate layer, and the process may further include directly connecting the adjacent layer, which includes a rubber-elastic adjustment layer, to the microporous, compressible intermediate layer. The process can also include providing an elastomer covering on lateral surfaces of the printing web. The elastomer covering may be formed to continuously increase in thickness from the exterior printing web in a direction of the internal layer. Further, a continuous connection may be provided between the elastomer covering and the adjustment layer. The continuous connection may be created by a vulcanizing process, and the vulcanization process can include hot vulcanization.

Moreover, the microporous, compressible intermediate elastomer layer can include strength-enhancing materials, and the strength-enhancing materials may include at least one of layers of woven materials, foil sections, and fibrous components.

In accordance with still another feature of the instant invention, the printing web can have at least one additional layer, and the process may further include connecting the exterior printing layer and the at least one additional layer as a unit, and connecting the unit to the flexible metal carrier layer. The at least one additional layer may include a microporous and/or compressible elastomer layer. Further, the at least one additional layer can include the adjacent layer. Alternatively, the microporous and/or compressible elastomer layer can include the adjacent layer.

The present invention is directed to a printing web structured and arranged for use on a printing cylinder. The printing web includes an interior carrying layer including a flexible metal plate adaptable to a curvature of the printing cylinder. The interior carrying layer is structured and arranged to face the printing cylinder during operation of the printing web. The printing web also includes an exterior printing layer, and an adjacent layer. The interior carrying layer is coupled to the adjacent layer via a bonding agent.

According to a feature of the invention, the printing web can also include a microporous and/or compressible intermediate elastomer layer. The adjacent layer may be directly connected to said adjacent layer.

In accordance with another feature of the instant invention, the adjacent layer may include a microporous and/or compressible elastomer layer.

In accordance with yet another feature of the present invention, a woven layer may be arranged between the exterior layer and the adjacent layer. Further, a microporous and/or compressible intermediate elastomer layer can be arranged between the woven layer and the adjacent layer.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a cross-section of layers of a printing web according to the invention; and

FIG. 2 illustrates a printing web with an elastomer lateral surface coating.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

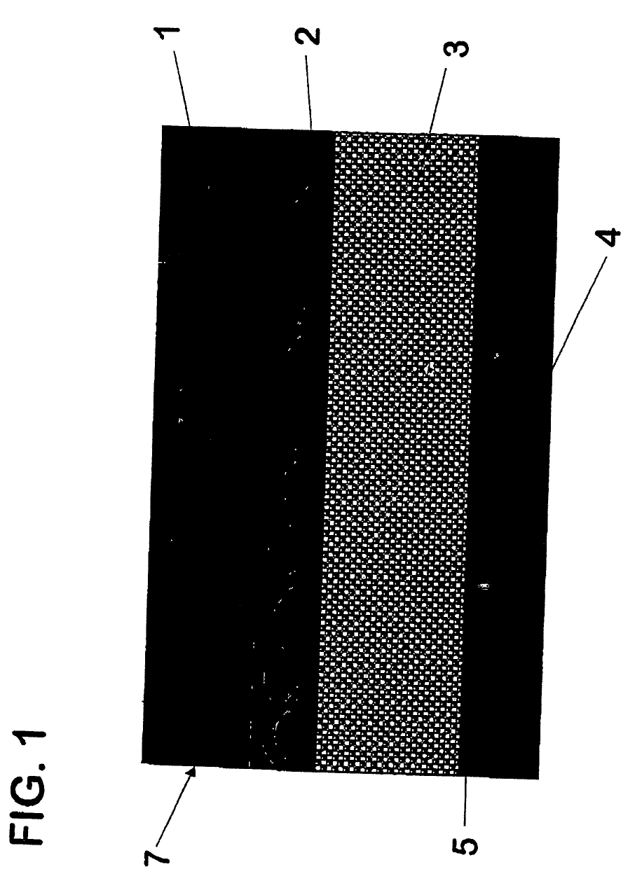

The printing web shown in FIG. 1 comprises an elastomer printing layer 1, a woven layer 2 arranged thereunder, an elastomer intermediate layer 3 connected to the woven layer 2, and a carrying layer 4 that rests on the printing cylinder (not shown) during use of the printing web. In order to create a connection of elastomer intermediate layer 3 to carrying layer 4 that is stable on a long-term basis, a rubber-metal bonding agent 5 is provided between these layers. Rubber-metal bonding agent 5 is selected so that forces acting on the printing web during the printing process can be conducted from printing layer 1 by way of the layer structure described above to carrying layer 4 without changes with respect to the connection of carrying layer 4 to elastomer intermediate layer 3. Certain layer thicknesses have been proven to be especially advantageous, e.g., the thickness of carrying layer 4 can be approximately 0.2 mm while a thickness range of about 0.85 to 0.88 mm can be selected for elastomer intermediate layer 3.

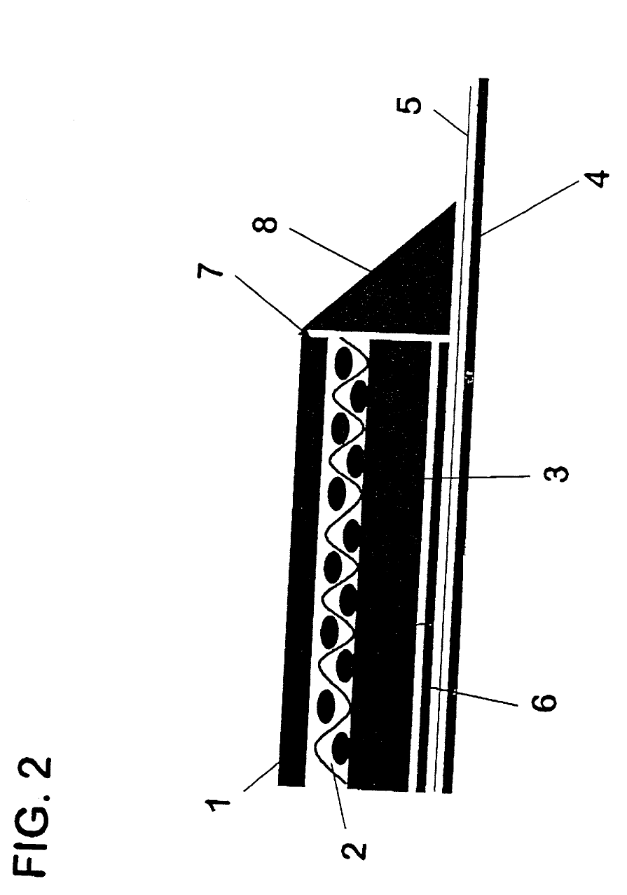

It can be seen from the sectioned depiction of a printing web according to FIG. 2 that a compensating layer 6 made, e.g., from an elastomer material, may adjoin the layer structure that includes printing layer 1, woven layer 2, and elastomer intermediate layer 3. Compensating layer 6 is adhesively connected to elastomer intermediate layer 3 and to carrying layer 4 by rubber-metal bonding agent 5. Moreover, compensating layer 6 is adhesively connected to an elastomer covering 8 provided on a lateral surface 7 of the printing web. Elastomer covering 8 adheres to lateral surface 7 along its entire height. Thus, it is ensured that fluids and washing fluids used during the printing process cannot arrive in woven layer 2 so as to damage the interior composition of the layer structure. Optionally, woven layer 2 may be omitted, and strength-increasing materials, e.g., layers of woven materials, foil sections, or fibrous components, may be placed in compressible elastomer intermediate layer 3 such that, optionally, a connection of elastomer covering 8 with the layer structure is not provided over the entire height of lateral surface 7 of the printing web.

Moreover, as can be seen in FIG. 2, elastomer covering 8 can continually increase in its thickness inwardly toward the printing cylinder, i.e., from elastomer printing layer 1 toward carrying layer 4, so that a significantly large surface of elastomer covering 8 is connected to carrying layer 4 in an adhesive manner by rubber-metal adhesive agent 5. Thus, especially tangential forces that arise when the printing web is being used, i.e., when the printing cylinder is rotating, can be transmitted into the layer structure of the printing web in such a way that an uncritical tension state at the low end of the printing web, i.e., in the transitional region of elastomer covering 8 is achieved in compensating layer 6.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

What is claimed:

1. A printing web for utilization on printing cylinders, comprising:
an internal carrying layer arranged to face the printing cylinder during use of said printing web, said internal carrying layer comprising a flexible metal sheet which is adaptable to a curvature of the printing cylinder and which is coupled to an adjacent layer via a bonding agent;
a microporous compressible intermediate layer; and
an exterior printing layer.

2. The printing web in accordance with claim 1, wherein said printing web is adapted for use in offset printing machines.

3. The printing web in accordance with claim 1, wherein said adjacent layer comprises said microporous, compressible intermediate layer.

4. The printing web in accordance with claim 3, further comprising an elastomer covering provided on lateral surfaces of said printing web.

5. The printing web in accordance with claim 4, wherein said elastomer covering is formed to continuously increase in thickness from said exterior printing web in a direction of said internal layer.

6. The printing web in accordance with claim 3, wherein a continuous connection is provided between said elastomer covering and said adjustment layer.

7. The printing web in accordance with claim 6, wherein said continuous connection is created by a vulcanizing process.

8. The printing web in accordance with claim 7, wherein the vulcanization process comprises hot vulcanization.

9. The printing web in accordance with claim 1, wherein said adjacent layer comprises a rubber-elastic adjustment layer which is directly connected to said microporous, compressible intermediate layer.

10. The printing web in accordance with claim 9, further comprising an elastomer covering provided on lateral surfaces of said printing web.

11. The printing web in accordance with claim 10, wherein said elastomer covering is formed to continuously increase in thickness from said exterior printing web in a direction of said internal layer.

12. The printing web in accordance with claim 10, wherein a continuous connection is provided between said elastomer covering and said adjustment layer.

13. The printing web in accordance with claim 12, wherein said continuous connection is created by a vulcanizing process.

14. The printing web in accordance with claim 13, wherein the vulcanization process comprises hot vulcanization.

15. The printing web in accordance with claim 1, wherein said microporous, compressible intermediate elastomer layer includes strength-enhancing materials.

16. The printing web in accordance with claim 15, wherein said strength-enhancing materials comprise at least one of layers of woven materials, foil sections, and fibrous components.

17. A process for producing a printing web for use on printing cylinders having an interior carrying layer, including a flexible metal plate, that faces the printing cylinder during operation of the printing web and an exterior printing layer, said process comprising:
forming the interior carrying layer with a flexible metal sheet in a shape of one of a roll and a strip, the flexible metal sheet being adaptable to a curvature of the printing cylinder; and
coupling the flexible metal sheet with an adjacent layer.

18. The process in accordance with claim 17, wherein the printing web is adapted for use in an offset printing press.

19. The process in accordance with claim 17, wherein the adjacent layer comprises a microporous and compressible intermediate layer.

20. The process in accordance with claim 19, further comprising providing an elastomer covering on lateral surfaces of the printing web.

21. The process in accordance with claim 20, wherein the elastomer covering is formed to continuously increase in thickness from the exterior printing web in a direction of the internal layer.

22. The printing web in accordance with claim 20, wherein a continuous connection is provided between the elastomer covering and the adjustment layer.

23. The printing web in accordance with claim 22, wherein the continuous connection is created by a vulcanizing process.

24. The printing web in accordance with claim 23, wherein the vulcanization process comprises hot vulcanization.

25. The process in accordance with claim 17, wherein the printing web further has a microporous, compressible intermediate layer, and the process further comprises:
directly connecting the adjacent layer, which comprises a rubber-elastic adjustment layer, to the microporous, compressible intermediate layer.

26. The process in accordance with claim 25, further comprising providing an elastomer covering on lateral surfaces of the printing web.

27. The process in accordance with claim 26, wherein the elastomer covering is formed to continuously increase in thickness from the exterior printing web in a direction of the internal layer.

28. The process in accordance with claim 26, wherein a continuous connection is provided between the elastomer covering and the adjustment layer.

29. The process in accordance with claim 28, wherein the continuous connection is created by a vulcanizing process.

30. The process in accordance with claim 29, wherein the vulcanization process comprises hot vulcanization.

31. The process in accordance with claim 17 wherein the microporous, compressible intermediate elastomer layer includes strength-enhancing materials.

32. The process in accordance with claim 31, wherein the strength-enhancing materials comprise at least one of layers of woven materials, foil sections, and fibrous components.

33. The process in accordance with claim 17, wherein the printing web further has at least one additional layer, and the process further comprises:
connecting the exterior printing layer and the at least one additional layer as a unit; and
connecting the unit to the flexible metal carrier layer.

34. The process in accordance with claim 33, wherein the at least one additional layer includes a microporous and/or compressible elastomer layer.

35. The process in accordance with claim 34, wherein the at least one additional layer further includes the adjacent layer.

36. The process in accordance with claim 34, wherein the microporous and/or compressible elastomer layer comprises the adjacent layer.

37. A printing web structured and arranged for use on a printing cylinder, said printing web comprising:
an interior carrying layer comprising a flexible metal plate being adaptable to a curvature of the printing cylinder, said interior carrying layer being structured and arranged to face the printing cylinder during operation of said printing web;
an exterior printing layer;
an adjacent layer,
wherein said interior carrying layer is coupled to said adjacent layer via a bonding agent.

38. The printing web in accordance with claim 37, further comprising a microporous and/or compressible intermediate elastomer layer.

39. The printing web in accordance with claim 38, wherein said adjacent layer is directly connected to said adjacent layer.

40. The printing web in accordance with claim 37, wherein said adjacent layer comprises a microporous and/or compressible elastomer layer.

41. The printing web in accordance with claim 37, further comprising a woven layer arranged between said exterior layer and said adjacent layer.

42. The printing web in accordance with claim 41, wherein a microporous and/or compressible intermediate elastomer layer is arranged between said woven layer and said adjacent layer.
